(19) United States
(12) Patent Application Publication
(10) Pub. No.: US 2010/0226314 A1
(43) Pub. Date: Sep. 9, 2010

(54) METHOD FOR USER EQUIPMENT PERFORMING DIRECT COMMUNICATIONS VIA HNB ACCESS SYSTEMS

(76) Inventor: Lixiang Xu, Beijing (CN)

Correspondence Address: THE FARRELL LAW FIRM, LLP, 290 Broadhollow Road, Suite 210E, Melville, NY, 11747, US

(21) Appl. No.: 12/680,676

(22) PCT Filed: Sep. 26, 2008
(86) PCT No.: PCT/KR08/05705

§ 371 Date: Mar. 29, 2010

(51) Int. Cl. H04W 74/00

(52) U.S. Cl. 370/328

(57) ABSTRACT

A method for User Equipments performing direct communication via HNB access system, the method comprising steps of: Initiating, by a first UE having a unique identifier GII in a closed subscriber group (CSG), a call request to a second UE in the same CSG to inform the HNB access system of the unique identifier GII of the second UE; establishing, by the HNB access system, communication bearer via the HNB access system for the first and the second UEs if the two UEs are under the same HNB access system. With the method for UEs performing direct communication via HNB access system of the present invention, transmission efficiency can be improved upon application of HNB, and network resources can also be saved.

### TECHNICAL FIELD

The present invention relates to communication field, in particular to a method for enabling two user equipments (UEs) to perform direct communication via Home Node B (HNB) access system, especially when both of the UEs are under the HNB access system.

### BACKGROUND ART

The system structure of SAE is illustrated in FIG. 1. The description on the SAE in FIG. 1 is given below.

User Equipment (hereinafter referred to as UE) 101 is a terminal device for receiving data. EUTRAN 102, also called ENB, is a radio access network in the LTE SAE and responsible for providing interface through which an LTE mobile phone accesses the radio network. And through interface S1, EUTRAN 102 connects to the mobility management entity (MME) 103 and the user plane entity, Serving Gateway, 104 of the mobile phone. MME 103 is responsible for managing mobile context and session context of UEs and saving user information on security. Serving Gateway 104 primarily provides the function of user plane. The interface S1-MME is responsible for providing UEs with radio access bearer establishment, and forwarding messages from UEs to MME through the radio access network. The combined function of MME 103 and Serving Gateway 104 is similar to that of the original SGSN (General Packet Radio Service (GPRS) supporting node) 106. And it is possible that both MME and Serving Gateway are located at the same physical entity. PDN Gateway 105 is responsible for functions like accounting, legally monitoring, etc.. Both the Serving Gateway and the PDN Gateway may be located at the same physical entity. SGSN 106 provides routing for data transmission in the existing UMTS. The existing SGSN finds a corresponding gateway GPRS supporting node (GGSN) according to Access Point Name (APN). HSS 107 is home subscription sub-system of UEs. It is responsible for storing user information, such as current location of UE, address of serving node, information on user security, UE-activated packet data protocol (PDP) context, and so on. PCRF 108 provides QoS policy and accounting criteria through interface S7.

In general, a user data stream reaches the Serving Gateway 104 via PDN Gateway 105. Then, through GPRS tunnel protocol (GTP) channel, data is sent by the Serving Gateway to the ENB where the UE is located, and in turn the ENB sends the data to the corresponding UE.

HNB is a type of Node B applied at home. It also can be applied at such site as university, company and so on. The difference between an HNB and a general macro Node B lies in that, in general, not all UEs can access an HNB. For instance, only the UEs in a user's home or the UEs that are allowed by the user to access the HNB can actually access the HNB at home. And for the HNB in a company, only the company's staff and its authorized cooperation partners can access the HNB. A group of HNBs (e.g., HNBs used in a company) having the same accessing subscriber cluster is called closed subscriber group (CSG).

With the existing techniques, if two UEs under the same HNB access system (HNB

AS) communicate with each other, the communication path is UE1<−−>HNB AS<−−>S-GW<−−>PDN GW<−−>S-GW<−−>HNB AS<−−>UE2. In this case, network resource has been wasted. And this communication mode is not very effective, either.

### DISCLOSURE OF INVENTION

### Technical Solution

An object of the present invention is to provide a method for enabling User Equipments to perform direct communication via HNB access system.

To achieve the above object, a method for User Equipments performing direct communication via HNB access system, the method comprising steps of: Initiating, by a first UE having a unique identifier GII in a closed subscriber group (CSG), a call request to a second UE in the same CSG to inform the HNB access system of the unique identifier GII of the second UE; establishing, by the HNB access system, communication bearer via the HNB access system for the first and the second UEs if the two UEs are under the same HNB access system.

With the method for UEs performing direct communication via HNB access system of the present invention, transmission efficiency can be improved upon application of HNB, and network resources can also be saved.

### BRIEF DESCRIPTION OF THE DRAWINGS

FIG. 1 shows the network structure of SAE;

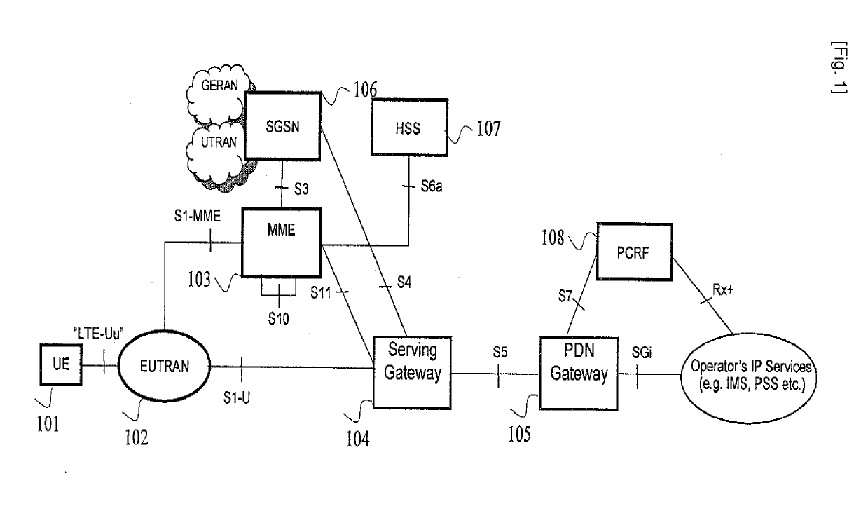

FIG. 2 illustrates a call establishment process (Embodiment 1);

FIG. 3 shows the operation flow of HNB access system in Embodiment 1;

FIG. 4 shows the operation flow of UE in Embodiment 1;

FIG. 5 shows the operation flow of MME in Embodiment 1;

FIG. 6 illustrates a call establishment process (Embodiment 2);

FIG. 7 shows an application scenario 1 where UEs move;

FIG. 8 shows a signaling flow corresponding to the application scenario 1;

FIG. 9 shows an application scenario 2 where UEs moves;

FIG. 10 shows a signaling flow corresponding to the application scenario 2;

FIG. 11 illustrates a call establishment process (Embodiment 5); and

FIG. 12 illustrates a call establishment process (Embodiment 6).

### BEST MODE FOR CARRYING OUT THE INVENTION

In the following description, the LTE system is taken as an example to explain the detailed implementation of the present invention. However, the method proposed in this invention is not limited to the LTE system, it can also be applied to HNB access system in 3G (UMTS) system and HNB access system in some future mobile communication systems.

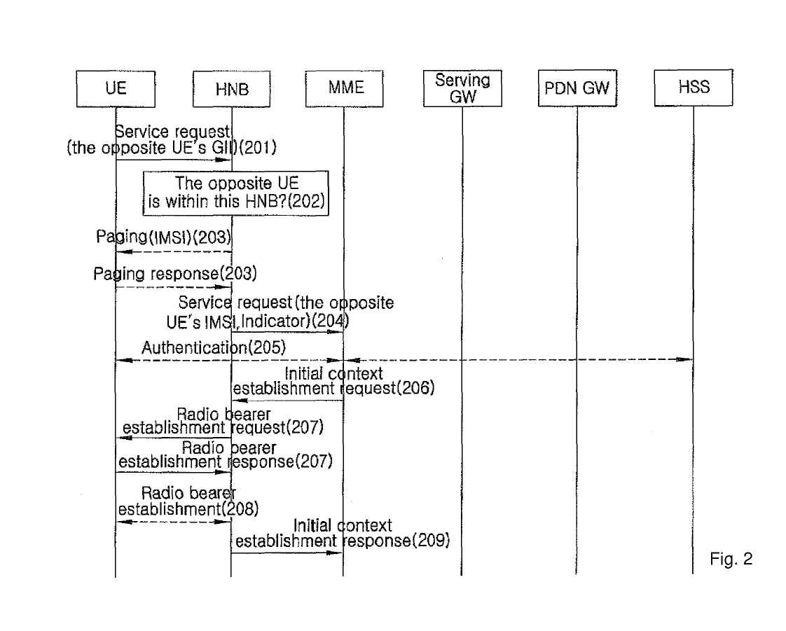

Embodiment 1 of the present invention is illustrated in FIG. 2. In this embodiment, the HNB access system can include HNB, or HNB and HNB GW. In the solution that the HNB access system includes the HNB and the HNB GW, the point where direct communication is implemented is the HNB. The HNB GW has the functions of forwarding messages between HNB and MME, taking charge of the mobility management of UEs within the control range of the HNB GW, etc.

The network (e.g., Operation Maintenance Center (OMC)) assigns an identifier GII, which is unique to a UE, to each of UEs within a CSG group. The identifier is saved in the corresponding UE. The International Mobile Subscriber Identifier (IMSI) and the GII of the UEs accessible in the group are saved in the HNB access system. Below is a detailed description to this figure. And detailed description on any technique irrelevant to the present invention is omitted.

Step 201, CSG UE (referred to as a first UE) under the HNB initiates a call to another CSG UE (referred to as a second UE). The UE sends an “uplink information transfer” message to the HNB. The message includes a non-access layer (referred to as NAS) message “service request”. Two approaches can be adopted by a UE to send its GII to the HNB access network. One approach is to include the GII in the uplink information transfer message in the uplink transmitting NAS message. The other one is to include the GII in a service request message. For the latter approach, it is necessary for the HNB to parse the uplink service request message. The service request message includes UE identifier, such as IMSI or temporary mobile subscriber identifier in the SAE system (S-TMSI), service type, and so on. The information element GII in the message is optional. The GII is required only in the case that a UE under the HNB initiates a call to another UE in the same group.

Step 202, according to the GII in the above message, the HNB checks whether the opposite-party UE is within the cell of the HNB or not. If the opposite-party UE is in an active status, the HNB can learn that the UE is connected to the HNB according to the context of the UE. If there is not any opposite-party UE in an active status, HNB 203 initiates a paging process to an opposite-party UE in the cell of HNB 203. The HNB, in the corresponding cell, sends a “paging” message to the opposite-party UE, the message including IMSI of the UE. After the opposite-party UE receives this paging message, it sends a paging response to the HNB.

Step 204, by means of an initial UE message or the uplink NAS transfer message, the

HNB sends a “service request” message to MME. The service request message includes IMSI or the S-TMSI of the UE and an indicator indicating whether it is necessary to establish a user plane of the core network. The information element “Indicator” in the message is optional. The indicator indicating whether it is necessary to establish a user plane of the core network can also be included in the access layer message initial UE message or the uplink NAS transfer message. If the opposite-party UE is not connected to the HNB or in active, and the HNB does not receive any paging response message, it indicates that the opposite-party UE is not under this HNB, and no indicator exists. And subsequent part of the call establishment flow is the same as that in the prior art. Therefore, detailed technical explanation is omitted here. If the opposite-party UE has be connected to the HNB and in active, or the HNB receives a paging response message, it indicates that the opposite-party UE is under this HNB, and there exists an indicator which is included in the service request message or in the access layer message initial UE message or the uplink NAS transfer message, with the indicator indicating that it is unnecessary to establish any user plane of the core network. The service request message, or the access layer message initial UE message or the uplink NAS transfer message can also includes the information element, the opposite-party UE's IMSI. After MME receives the Indicator indicating direct communication between the above two UEs, it saves this information. The information element, the opposite-party UE's IMSI, in the message is optional. The opposite-party UE's IMSI can be included in the message no matter whether the opposite-party UE is under the HNB or not, so as to inform MME of the identifiers of the two UEs. Also, the opposite-party UE's IMSI can be included in the message only when direct communication is performed. In the solution that the opposite-party UE's IMSI is included in the message only when direct communication is effected, no information element, Indicator, needs to be included in the service request message or the access layer message sending the service request message. And by learning whether the opposite-party UE's IMSI is included in the message or not, MME can decide whether it is necessary to establish a user plane or not.

Step 205, MME initiates an authentication process for the UEs.

Step 206, MME sends an “initial context establishment request” message to the HNB.

Step 207, the HNB allocates radio resources to the UE. If it is not necessary to establish any user plane on the network side (i.e., when direct communication can be enabled), it is not necessary for the HNB to assign a downlink Tunnel End Identifier (TEID) to interface S1. The HNB initiates a radio bearer establishment process between itself and the UE. The HNB sends a “radio bearer establishment request” message to the UE. The UE configures the radio resources according to the request, and then sends a “radio bearer establishment response” message to the HNB.

Step 208, if the HNB has decided to enable direct communication via the HNB, it initiates a radio bearer establishment process for the opposite-party UE. This process is the same as that in step 207, and thus no detailed technical explanation is given here. The HNB stores the correspondence between the bearers of the UEs in direct communication. In this way, during data transmission, data received through the bearer established for UE1 can be directly sent to the bearer established for UE2, and vice versa.

Step 209, the HNB sends an initial context establishment response message to MME. If it is not necessary to establish any user plane on the network side (corresponding to the case of direct communication), no TEID (assigned by HNB) is included in the message.

If the above process is intended to establish an IMS call, the IMS signaling is transmitted through a default bearer. The process of IMS signaling transmission is the same as that in the prior art, and thus detailed technical explanation is omitted here.

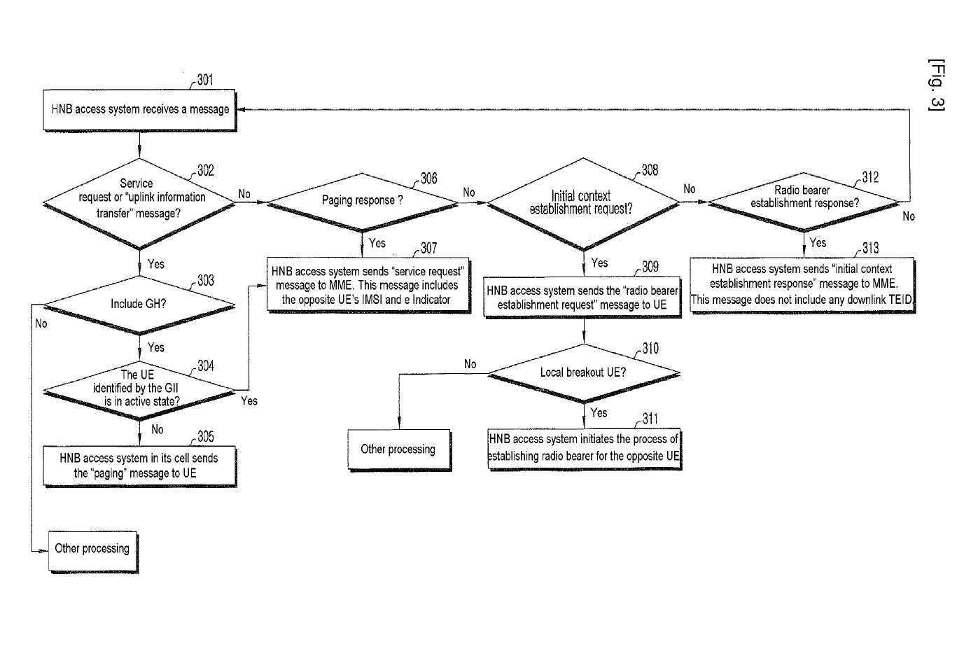

For Embodiments 1, 5 and 6, the operation flows of the HNB access system are illustrated in FIG. 3. Here, detailed technical description irrelevant to the present invention is omitted.

301 The HNB access system receives a message. 302 The HNB access system has received a service request message or an access layer message uplink information transfer message. 303 If no GII is included in the message received in 302, the HNB access system performs other processes (this is irrelevant to the present invention, no detail will be given here). If some GII is included in the message received in 302, then 304 the HNB access system checks whether the UE identified by this GII is active in the HNB access system or not. If yes, the process proceeds to step 307. If no, the process proceeds step 305.

305 The HNB access system sends a “paging” message to the UE in the cell of this HNB. This message includes the UE's IMSI. If no response comes from UE after the paging process completes, the process proceeds step 307.

306 The HNB access system receives a paging response message.

307 The HNB access system sends a service request message to MME, the message including such information element as the UE's IMSI or S-TMSI. If the opposite-party UE is under this HNB access system, the HNB access system can optionally inform MME of the opposite-party UE's IMSI. After receiving this message, MME stores the information on direct communication of the two UEs. The information element, the opposite-party UE's IMSI, is optional. The opposite-party UE's IMSI can be included in the message no matter whether the opposite-party UE is under the HNB or not, so as to inform MME of the identifiers of the two UEs. Also, the opposite-party UE's IMSI can be included in the message only when direct communication can be enabled (i.e., the opposite-party UE is active in the HNB access system or the HNB access system has received a paging response message). In the solution that the opposite-party UE's IMSI is included in the message only when direct communication can be enabled, no information element, Indicator, needs to be included in the service request message or the access layer message sending the service request message. And by means of the information whether the opposite-party UE's IMSI is included in the message or not, MME can learn about whether it is necessary to establish a user plane or not. If the message includes the opposite-party UE's IMSI, it is not necessary to establish any user plane on the network side, otherwise, it is necessary to establish the user plane on the network side. For the first solution (no matter whether the opposite-party UE is under the HNB access system or not, the service request always includes the opposite-party UE's IMSI), whether it is necessary to establish a user plane or not is indicated by the service request message or the Indicator included in the access layer message transmitting service request message. If any Indicator exists, it is not necessary to establish a user plane, otherwise, it is necessary to establish a user plane. The information element, Indicator, in the message is optional.

308 The HNB access system receives an initial context establishment request message.

309 The HNB access system sends a radio bearer establishment request message to the UE to establish a radio bearer for the UE.

310 In the case of direct communication, 311 the HNB access system initiates a radio bearer establishment process for the opposite-party UE. This process is the same as in the prior art, and thus detailed technical explanation is omitted here.

312 The HNB access system receives a radio bearer establishment response message, and the radio resource establishment for the two UEs is successful. The HNB stores the correspondence between the bearers of the UEs in direct communication. In this way, during data transmission, data received through the bearer established for UE1 can be directly sent to the bearer established for UE2, and vice versa. The HNB access system sends an “initial context establishment response” message to MME. And in the case of direct communication, no downlink TEID is included in the message.

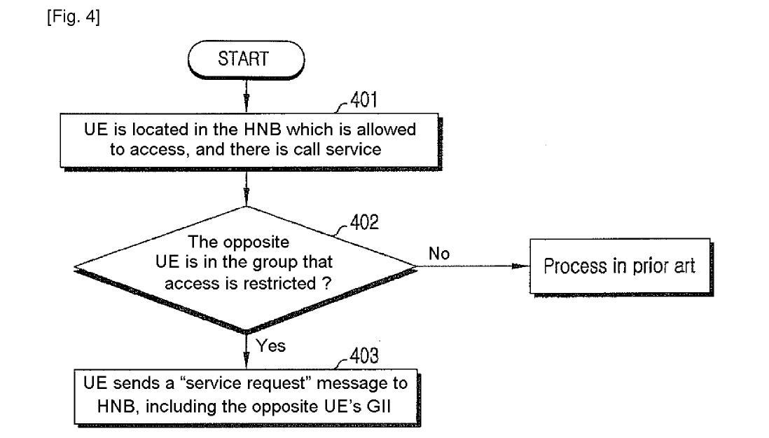

For Embodiments 1, 5 and 6, the operation flows of UEs are illustrated in FIG. 4. Here, detailed technical description irrelevant to the present invention is omitted.

401 For the reasons like the request from user interface, it is necessary for a UE to call another UE. The UE is in the HNB access system, and it is a subscriber within the CSG group. 402 The UE that is the opposite-party of the calling is within the same CSG. 403 By means of the uplink information transfer message, the UE sends a “service request” message to the HNB access system. The uplink information transfer message or the service request message includes the opposite-party UE's GII. Other steps of the call establishment process are the same as that in the prior art, and thus detailed technical explanation is omitted here.

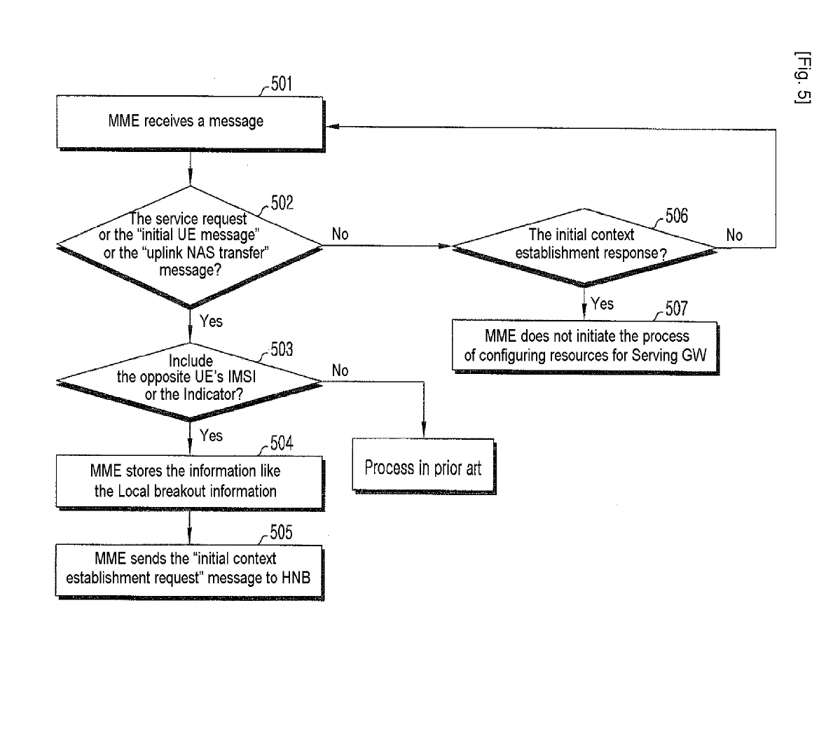

For Embodiments 1, 5 and 6, the operation flows of MME are illustrated in FIG. 5. Here, detailed technical description irrelevant to the present invention is omitted.

501 MME receives a message. 502 MME has received an initial UE message or an uplink NAS transfer message, which contains a “service request” message. 503 The “service request” message or the access layer message includes the opposite-party UE's IMSI or Indicator indicating that it is not necessary to establish a user plane on the network side. 504 MME stores this information. With respect to the description illustrated in FIG. 2, the opposite-party UE's IMSI, which is included in the service request message or in the access layer message for sending the service request, can indicate that the two UEs are accessible UEs in the cell of current HNB access system. As a result, the user plane is in the state of direct communication. And the information on the two UEs' IMSI and QoS is saved in MME. Also, another information element, i.e., the Indicator, can be adopted to indicate that whether direct communication is currently between the two UEs. 505 MME sends an “initial context establishment request” message to the HNB access system, such information elements as the Serving GW address and the uplink TEID in the message being optional. If the user plane between the two UEs is in the state of direct communication, neither Serving GW address nor TEID is included in the message.

506 MME receives the “initial context establishment response” message from the HNB access system. 507 In the case that the user plane between the two UEs is in the state of direct communication, even if a success response exists, MME will not initiate any process of configuring Serving GW resources (i.e., the process of the S11 interface updating bearer context in the prior art).

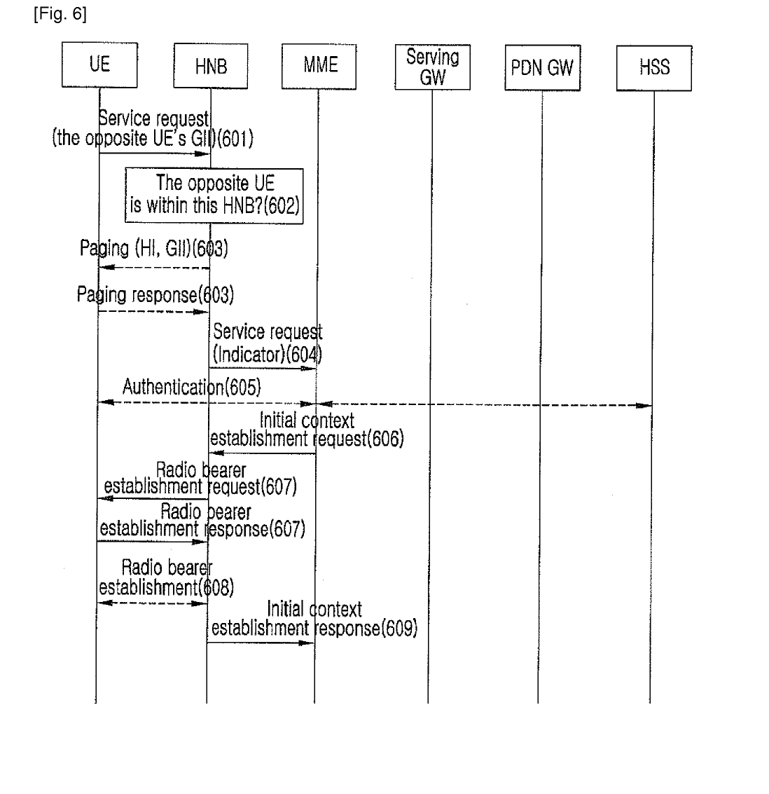

Embodiment 2 of the present invention is illustrated in FIG. 6. The network (e.g., Operation Maintenance Center (OMC)) assigns an identifier GII, which is unique to a UE, to each of UEs within a CSG group. The identifier is saved in the corresponding UE. The GII of the UEs accessible in the group are saved in the HNB access system. Below is a detailed description to this figure. And detailed description on any technique irrelevant to the present invention is omitted.

Step 601, a CSG UE in the HNB initiates a call to another UE in the same CSG. The UE sends a “service request” message to the HNB access system by way of an uplink information transfer message. The UE informs the HNB access system of the opposite-party UE's GII. The information element GII is optional. It is necessary only when the UE under an accessible HNB calls another UE in the same group. UE can send the GII to the HNB access system by way of either the uplink information transfer message or the service request message. In the latter case, it is necessary for the HNB access system to parse the service request message.

Step 602, according to the GII in the message, the HNB access system checks whether the opposite-party UE is within the cell of this HNB or not. If the opposite-party UE is in an active state, the HNB access system can learn whether the opposite-party UE is connected to the HNB access system or not according to the UE context. If there is no opposite-party UE in active, 603 the HNB access system initiates a paging process to the opposite-party UE in the cell of the HNB access system. The HNB access system in the corresponding cell sends a “paging” message to the opposite-party UE, the message including the HNB's identifier HI and the opposite-party UE's GII. After the opposite-party UE receives this paging message, it sends a paging response message to the HNB access system, the message including the opposite-party UE's IMSI.

Steps 604 through 609 are the same as the above steps 204 through 209, and thus detailed explanation is omitted here.

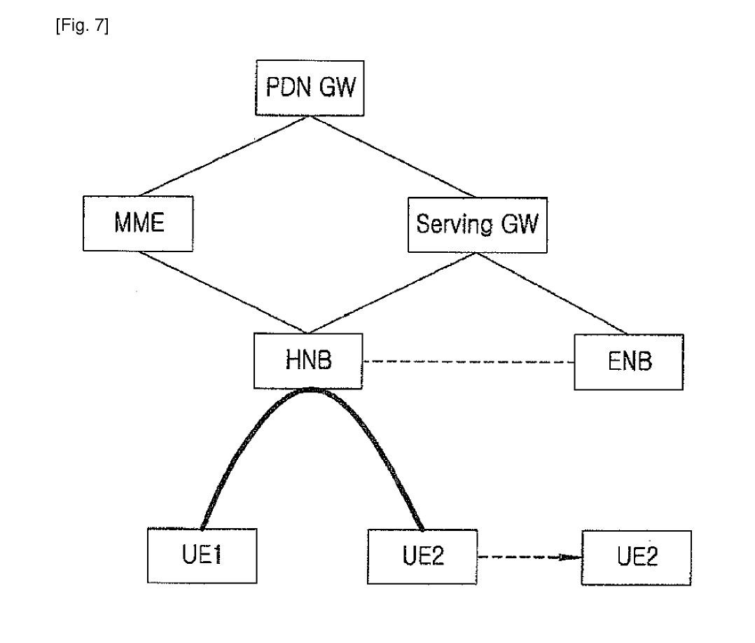

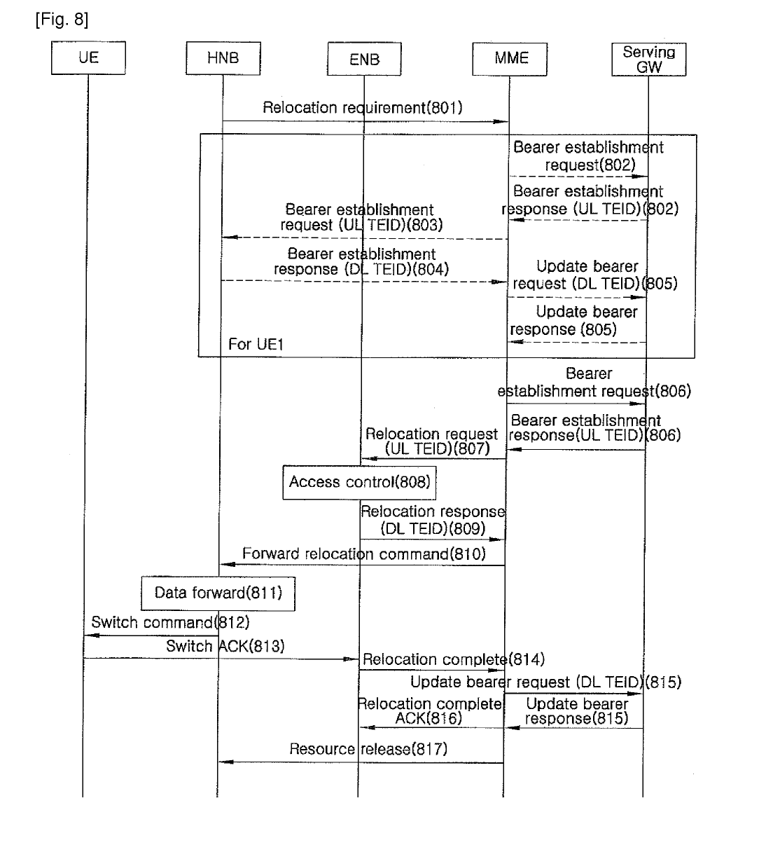

Embodiment 3 of the present invention is illustrated in FIG. 7. Direct communication is performed between UE1 and UE2 under the HNB access system. UE2 moves to a macro ENB. The corresponding signaling flow is illustrated in FIG. 8. Below is a detailed description on this figure. Here, detailed description on the techniques irrelevant to the present invention is omitted.

Step 801 the HNB access system sends a re-location request message to MME. According to context information, MME learns about that the UE1 is in the state of direct communication.

MME initiates the process of establishing a bearer for UE1, the process including steps 802 through 805. Here, the process of user plane bearer establishment of Serving GW-upstream nodes like PDN GW is omitted.

Step 802, MME sends a “bearer establishment request” message to the Serving GW. The Serving GW sends a “bearer establishment response” message to MME, the message including uplink TEID assigned by the Serving GW.

Step 803, MME sends a “bearer establishment request” message to the HNB access system, the message including the uplink TEID. The HNB access system assigns downlink TEID. 804 The HNB access system sends a “bearer establishment response” message to MME, the message including the downlink TEID.

Step 805 MME sends a “bearer update request” message to the Serving GW, the message including the downlink TEID. The Serving GW stores this information. The Serving GW sends a “bearer update response” message to MME.

Step 806, MME sends a “bearer establishment request” message to the Serving GW. The Serving GW sends a “bearer establishment response” message to MME, the message including uplink TEID assigned by the Serving GW.

The order of the steps 802 through 806 can be changed.

Step 807, MME sends a “re-location request” message to the target ENB, the message including the uplink TEID assigned by the Serving GW.

Step 808, the ENB performs access control on UE, e.g., whether the radio resource is available or not.

Step 809, the ENB sends a “re-location response” message to MME, the message including downlink TEID assigned by the ENB.

Step 810, MME sends a “forward re-location command” message to the HNB access system.

Step 811, the HNB access system starts to forward data.

Step 812, the HNB access system sends a “switch command” message to the UE.

Step 813, the UE performs physical layer synchronization and sends a “Switch ACK” message to ENB.

Step 814, the ENB sends a “re-location complete” message to MME. MME updates the context information.

Step 815, MME sends a “bearer update request” message to the Serving GW, the message including the downlink TEID. The Serving GW stores this information. The Serving GW sends a “bearer update response” message to MME.

Step 816, MME sends a “re-location complete ACK” message to the ENB.

Step 817, MME initiates the process of resource release. MME sends a “resource release” message to the HNB access system. The HNB releases the radio resources allocated to UE1.

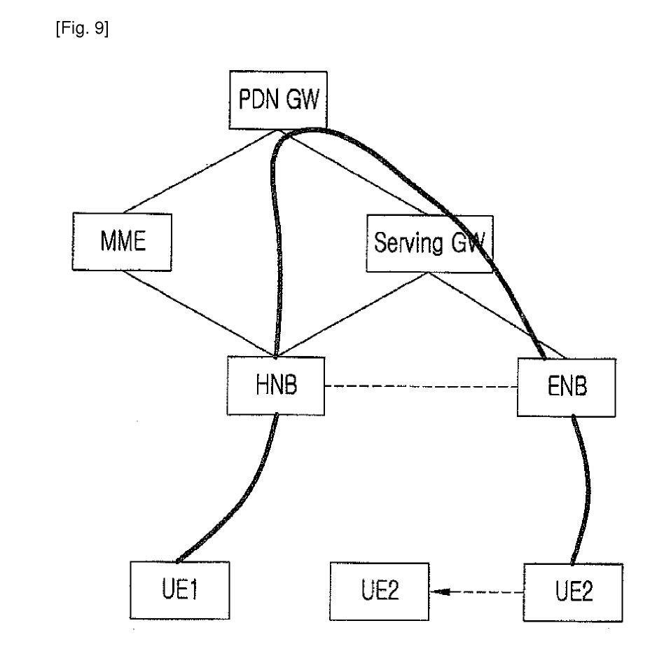

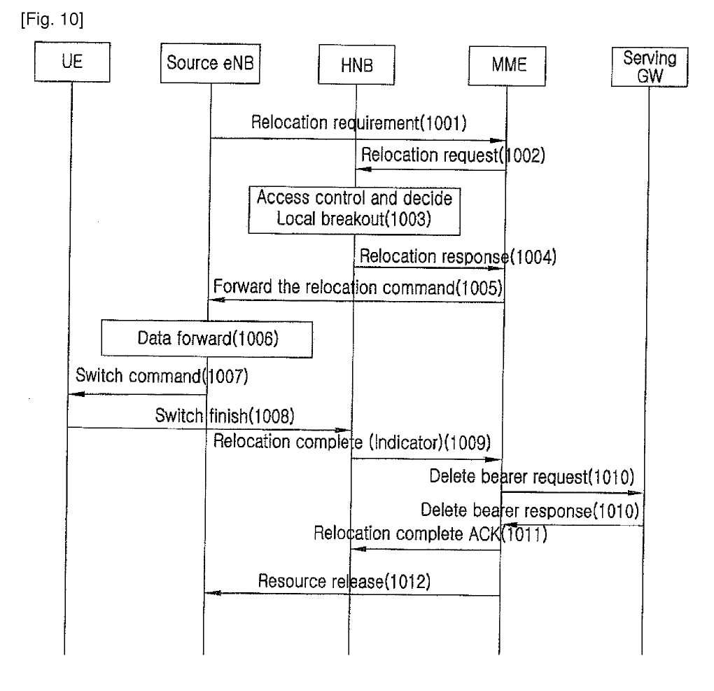

Embodiment 4 of the present invention is illustrated in FIG. 9. UE1 is communicating with UE2. UE2 moves from the ENB to the HNB access system where UE1 is located. The corresponding signaling flow is illustrated in FIG. 10. Below is a detailed description on this figure. Here, detailed description on the techniques irrelevant to the present invention is omitted.

Step 1001 Source eNB sends a “re-location requirement” message to MME. 1002 MME sends a “re-location request” message to the HNB access system, the message including uplink TEID assigned by the Serving GW and the Serving GW address.

Step 1003, the HNB access system performs access control on UE, e.g., whether the radio resource is available or not. As described in Embodiments 1 and 2, during the call establishment process, the HNB access system stores the two communication parties' IMSIs and GIIs, and the identifiers of the bearers established for the two UEs. With this information, the HNB access system learns that UE2 is communicating with UE1. UE1 is under the HNB access system, and UE2 also moves into this HNB access system. Therefore, the HNB access system can decide the implementation of direct communication.

Step 1004, the HNB access system sends a “re-location response” message to MME, the message including TEID assigned by the HNB access system.

Step 1005, MME sends a “forward re-location command” message to the ENB.

Step 1006, the ENB starts to forward data.

Step 1007, the HNB access system sends a “switch command” message to the UE.

Step 1008, the UE performs physical layer synchronization and sends a “Switch ACK” message to the HNB access system.

Step 1009, the HNB access system sends a “re-location complete” message to MME. This message includes Indicator indicating that the user plane resource can be released. The information element Indicator is optional. The method also can include the information element UE1's IMSI. After MME receives this message, it stores the information on direct communication between the two UEs. The information element UE1's IMSI is optional.

Step 1010 MME sends a “bearer delete request” message to the Serving GW. The Serving GW releases the resources. The Serving GW sends a “bearer delete response” message to MME.

Step 1011, MME sends a “re-location complete ACK” message to the HNB access system.

Step 1012, MME initiates the process of resource release. MME sends a “resource release” message to the ENB. The ENB releases the resources allocated to UE2.

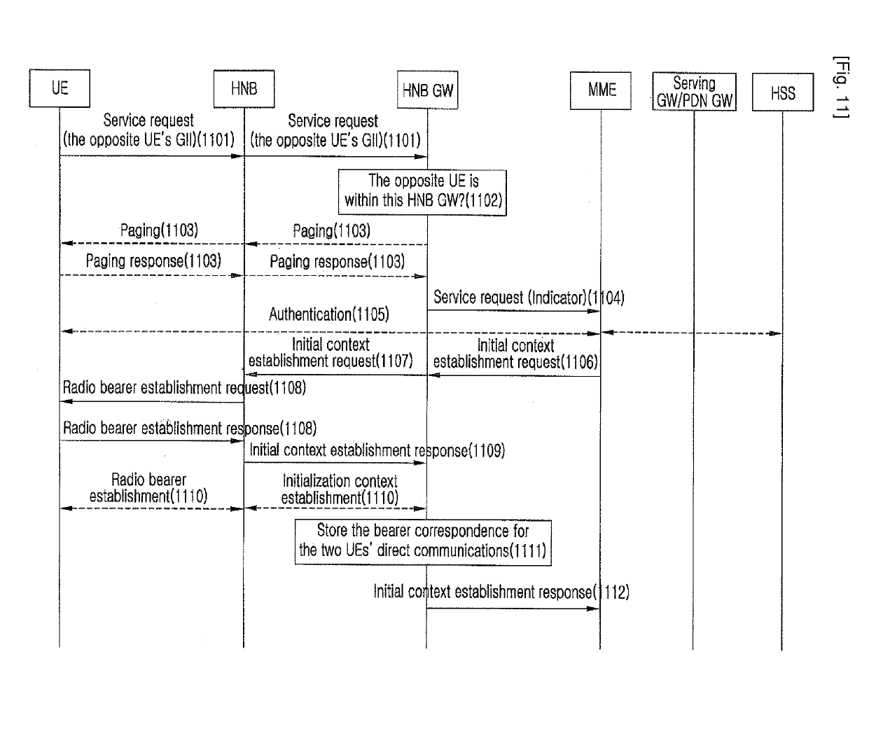

Embodiment 5 of the present invention is illustrated in FIG. 11. In this embodiment, the point of direct communication is at the HNB GW. Below is a detailed description on this embodiment. Here, detailed description on the techniques irrelevant to the present invention is omitted.

The network (e.g., Operation Maintenance Center (OMC)) assigns an identifier GII, which is unique to a UE, to each of UEs within a CSG group. The identifier is saved in the corresponding UE. The International Mobile Subscriber Identifier (IMSI) and the GII of the UEs accessible in the group are saved in the HNB GW.

Step 1101, CSG UE under the HNB initiates a call to another CSG UE. The UE sends an “uplink information transfer” message to the HNB. The message includes a non-access layer (referred to as NAS) message “service request”. Two approaches can be adopted by a UE to send its GII to the HNB access network. One approach is to include the GII in the uplink information transfer message in the uplink transmitting NAS message. The other one is to include the GII in a service request message. For the former approach, the HNB includes the GII in the message for forwarding the service request message between the HNB and the HNB GW. For the latter approach, it is necessary for the HNB to parse the uplink service request message. The service request message includes UE identifier, such as IMSI or temporary mobile subscriber identifier in the SAE system (S-TMSI), service type, and so on. The information element GII in the message is optional. The GII is required only in the case that a UE under the HNB initiates a call to another UE in the same group.

Step 1102, according to the GII in the message, the HNB GW checks whether the opposite-party UE is within a cell under the control of the HNB GW or not. If the opposite-party UE is in an active state, the HNB GW can learn whether the UE is connected to the HNB under the control of the HNB GW or not, according to the UE's context information. If there is no active UE, 1103 the HNB GW initiates a paging process to the opposite-party UE in the cell of the HNB contained the CSG. The HNB GW sends the “paging” message to the HNBs in the CSG, and the HNB in a corresponding cell sends the “paging” message to the opposite-party UE, the message including the UE's IMSI. After the opposite-party UE receives this paging message, it sends a paging response to the HNB where the UE is located, and the HNB sends the “paging response” message to the HNB GW.

Step 1104, by means of an initial UE message or an uplink NAS transfer message, the HNB GW sends a “service request” message to MME. The service request message includes such information elements as the UE's IMSI or S-TMSI, and the indicator, Indicator, indicating whether it is necessary to establish a user plane of the core network or not. The information element “Indicator” in the message is optional. The indicator indicating whether it is necessary to establish a user plane of the core network can also be included in an access layer message “initial UE” message or the uplink NAS transfer message, which is used to forward the service request. If the opposite-party UE is not connected to the HNB in this CSG or in active, and the HNB GW does not receive any paging response message, it indicates that the opposite-party UE is not under the HNB in this CSG, and no indicator exists in the service request or the access layer message which forwards the service request. And subsequent part of the call establishment flow is the same as that in the prior art. Therefore, detailed technical explanation is omitted here. If the opposite-party UE has be connected to the HNB in this CSG and in active, or the HNB GW receives a paging response message, it indicates that the opposite-party UE is under the HNB in this CSG, and there exists an indicator which is included in the service request message or in the access layer message initial UE message or the uplink NAS transfer message, with the indicator indicating that it is unnecessary to establish any user plane of the core network. The service request message, or the access layer message initial UE message or the uplink NAS transfer message can also includes the information element, the opposite-party UE's IMSI. After MME receives the Indicator indicating direct communication between the above two UEs, it saves this information. The information element, the opposite-party UE's IMSI, in the message is optional. The opposite-party UE's IMSI can be included in the message no matter whether the opposite-party UE is under the HNB in this CSG or not, so as to inform MME of the identifiers of the two UEs. Also, the opposite-party UE's IMSI can be included in the message only when direct communication is performed. In the solution that the opposite-party UE's IMSI is included in the message only when direct communication is effected by the HNB GW, no information element, Indicator, needs to be included in the service request message or the access layer message for sending the service request message. And by learning whether the opposite-party UE's IMSI is included in the message or not, MME can decide whether it is necessary to establish a user plane on the core network side or not.

Step 1105, MME initiates an authentication process for the UEs.

Step 1106, MME sends an “initial context establishment request” message to the HNB GW.

Step 1107, the HNB GW sends “initial context establishment request” message to the HNB for allocating radio resources to the UE. Step 1108, The HNB initiates a radio bearer establishment process between itself and the UE. The HNB sends a “radio bearer establishment request” message to the UE. The UE configures the radio resources according to the request, and then sends a “radio bearer establishment response” message to the HNB. Step 1109, the HNB sends “initial context establishment response” message to the HNB GW.

Step 1110, if the HNB GW has decided to enable direct communication via the HNB GW, it initiates a radio bearer establishment process for the opposite-party UE. This process is the same as that in step 1107 to 1109, and thus no detailed technical explanation is given here.

Step 1111, The HNB GW stores the correspondence between the bearers of the UEs in direct communication. In this way, during data transmission, data received through the bearer established for UE1 can be directly sent to the bearer established for UE2, and vice versa.

Step 1112, the HNB GW sends the “initial context establishment response” message to MME. If it is not necessary to establish any user plane on the network side (corresponding to the case of direct communication), no TEID (assigned by HNB GW) is included in the message.

In this embodiment, the HNBs where the two UEs are located can be the same one or different ones in this CSG.

If the above process is intended to establish an IMS call, the IMS signaling is transmitted through default bearer. The process of IMS signaling transmission is the same as that in the prior art, detailed technical explanation is omitted here.

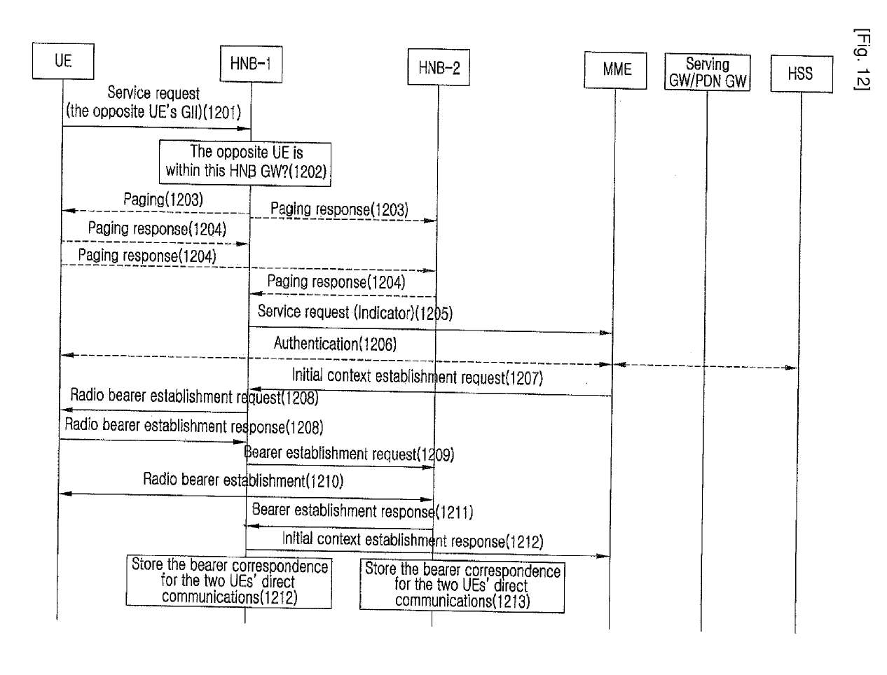

Embodiment 6 of the present invention is illustrated in FIG. 12. In this embodiment, the point of direct communication is in the HNB. Below is a detailed description to this embodiment. Here, detailed description on the techniques irrelevant to the present invention is omitted. In this embodiment, the HNB access system can also includes the HNB GW, which performs the same function as that in the case of no direct communication. Therefore, no description is made to the functions of the HNB GW, such as forwarding the messages between the HNB and MME.

The network (e.g., Operation Maintenance Center (OMC)) assigns an identifier GII, which is unique to a UE, to each of UEs within a CSG group. The identifier is saved in the corresponding UE. The International Mobile Subscriber Identifier (IMSI) and the GII of the UEs accessible in the group are saved in the HNB GW or the HNB.

Step 1201, CSG UE under the HNB initiates a call to another CSG UE. The UE sends an “uplink information transfer” message to the HNB. The message includes a non-access layer (referred to as NAS) message “service request”. Two approaches can be adopted by a UE to send its GII to the HNB access network. One approach is to include the GII in the uplink information transfer message in the uplink transmitting NAS message. The other one is to include the GII in a service request message. For the latter approach, it is necessary for the HNB to parse the uplink service request message. The service request message includes UE identifier, such as IMSI or temporary mobile subscriber identifier in the SAE system (S-TMSI), service type, and so on. The information element GII in the message is optional. The GII is required only in the case that a UE under the HNB initiates a call to another UE in the same group.

Step 1202, according to the GII in the above message, the HNB checks whether the opposite-party UE is within the cell of the HNB in this CSG or not. If the opposite-party UE is in an active status, the HNB can learn that the UE is connected to the HNB according to the context of the UE. If there is not any opposite-party UE in an active status, 1203 HNB initiates a paging process to an opposite-party UE in the cell of HNB 203. The HNB, in the corresponding cell, sends a “paging” message to the opposite-party UE. At the same time, the HNB sends paging messages to other HNBs in the same CSG, and the other HNBs initiate a call to the UE. If the UE in one of the other HNBs is in active, this HNB does not need to initiate a air-interface call to the UE. The “paging” message contains the IMSI of the UE. Step 1204, after the opposite-party UE receives this paging message, it sends a paging response to the HNB where the UE is located. The HNB (e.g., HNB-2) which has received the paging response message from the UE sends the paging response message to the HNB (e.g., HNB-1) which has sent the paging message.

Step 1205, by means of an initial UE message or the uplink NAS transfer message, the HNB sends a “service request” message to MME. The service request message includes IMSI or the S-TMSI of the UE and an indicator indicating whether it is necessary to establish a user plane of the core network. The information element “Indicator” in the message is optional. The indicator indicating whether it is necessary to establish a user plane of the core network can also be included in the access layer message initial UE message or the uplink NAS transfer message. If the opposite-party UE is not connected to the HNB of this CSG or in active, and the HNB does not receive any paging response message, it indicates that the opposite-party UE is not under the HNB of this CSG, and no indicator exists in the service request or the access message which is used to forward the service request. And subsequent part of the call establishment flow is the same as that in the prior art. Therefore, detailed technical explanation is omitted here. If the opposite-party UE has be connected to the HNB of this CSG and in active, or the HNB receives a paging response message, it indicates that the opposite-party UE is under this HNB, and there exists an indicator which is included in the service request message or in the access layer message initial UE message or the uplink NAS transfer message, with the indicator indicating that it is un-necessary to establish any user plane of the core network. The service request message, or the access layer message initial UE message or the uplink NAS transfer message can also includes the information element, the opposite-party UE's IMSI. After MME receives the Indicator indicating direct communication between the above two UEs, it saves this information. The information element, the opposite-party UE's IMSI, in the message is optional. The opposite-party UE's IMSI can be included in the message no matter whether the opposite-party UE is under the HNB or not, so as to inform MME of the identifiers of the two UEs. Also, the opposite-party UE's IMSI can be included in the message only when direct communication is performed. In the solution that the opposite-party UE's IMSI is included in the message only when direct communication is effected, no information element, Indicator, needs to be included in the service request message or the access layer message sending the service request message. And by learning whether the opposite-party UE's IMSI is included in the message or not, MME can decide whether it is necessary to establish a user plane on the core network side or not.

Step 1206, MME initiates an authentication process for the UEs.

Step 1207, MME sends an “initial context establishment request” message to the HNB.

Step 1208, the HNB initiates a radio bearer establishment process between itself and the UE. The HNB sends a “radio bearer establishment request” message to the UE. The UE configures the radio resources according to the request, and then sends a “radio bearer establishment response” message to the HNB.

Step 1209, if the UE is under the other HNB in the same CSG, the HNB sends a “bearer establishment request” message to the HNB where the opposite-party UE is located. The message contains information for establishing a bearer, such as QoS, TEID and UE AP ID allocated by source HNB (e.g., HNB-1). Step 1210, the HNB where the opposite-party UE is located initiates a radio bearer establishment process between itself and the UE. This process is the same as that in step 1208. After receiving a success response from the UE, the HNB-2 sends a “bearer establishment response” message to the HNB-1. The bearer establishment response message contains TEID allocated by the HNB-2.

Step 1212, the HNB sends an initial context establishment response message to MME. If it is not necessary to establish any user plane on the network side (corresponding to the case of direct communication), no TEID (assigned by HNB) is included in the message.

Step 1213, The HNB stores the correspondence between the bearers of the UEs in direct communication. In this way, during data transmission, data received through the bearer established for UE1 can be directly sent to the bearer established for UE2, and vice versa.

If the above process is intended to establish an IMS call, the IMS signaling is transmitted through a default bearer. The process of IMS signaling transmission is the same as that in the prior art, and thus detailed technical explanation is omitted here.

Although the invention has been described with respect to the above embodiments, these embodiments are intended for explanation, rather than limiting the present invention. Those skilled in the art could easily modify, add, delete any step of these embodiments, without departing from the spirit and scope of the present invention.

1. A method for User Equipments (UEs) performing direct communication via HNB access system, the method comprising steps of:
Initiating, by a first UE having a unique identifier GII in a closed subscriber group (CSG), a call request to a second UE in the same CSG to inform the HNB access system of the unique identifier GII of the second UE;
establishing, by the HNB access system, communication bearers via the HNB access system for the first and the second UEs if the two UEs are under the same HNB access system.

2. The method of claim 1, wherein said HNB access system saves the correspondence between the communication bearers for the first and the second UEs.

3. The method of claim 1, wherein said HNB access system initiates, in its own cell, a paging message to the second UE.

4. The method of claim 1, further comprising step of informing, by the HNB, MME of an indicator indicating whether direct communication is performed or not.

5. The method of claim 1, wherein each UE saves GIIs of the other UEs in said CSG.

6. The method of claim 1, wherein the HNB access system saves GIIs and IMSIs of the UEs in said CSG.

7. The method of claim 3, wherein said paging message includes IMSIs of the UEs.

8. The method of claim 3, wherein said paging message includes the identifier HI of the HNB access system and the GII of the opposite-party UE.

9. The method of claim 1, wherein said GII is contained in an uplink information transfer message or a service request message.

10. The method of claim 1, wherein said access system includes HNB or, HNB and HNB GW.
